(19) United States
(12) Patent Application Publication
(10) Pub. No.: US 2018/0078091 A1
(43) Pub. Date: Mar. 22, 2018

(54) Surface-Mounted Toasting Device

(71) Applicant: Matthew Chubb, Narre Warren South (AU)

(72) Inventor: Matthew Chubb, Narre Warren South (AU)

(21) Appl. No.: 15/271,976

(22) Filed: Sep. 21, 2016

(51) Int. Cl. A47J 37/08

(52) U.S. Cl. CPC A47J 37/0871

(57) ABSTRACT

A surface-mounted toasting device for surface-mounted installation includes a toaster with a housing. A top is coupled to the housing. The top extends outwardly past the housing forming a rim. A seal, complimentary to the rim, is coupled to an underside of the rim. A control panel is coupled to and positioned in the top of the toaster. The device also includes a cover that is complimentary to the top.

### BACKGROUND OF THE DISCLOSURE

### Field of the Disclosure

The disclosure relates to toasting devices and more particularly pertains to a new toasting device for surface-mounted installation.

### SUMMARY OF THE DISCLOSURE

An embodiment of the disclosure meets the needs presented above by generally comprising a toaster with a housing. A top is coupled to the housing. The top extends outwardly past the housing forming a rim. A seal, complimentary to the rim, is coupled to an underside of the rim. A control panel is coupled to and positioned in the top of the toaster. The device also includes a cover that is complimentary to the top.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric open view of a surface-mounted toasting device according to an embodiment of the disclosure.

FIG. 2 is an isometric closed view of an embodiment of the disclosure.

FIG. 3 is a top view of an embodiment of the disclosure.

FIG. 4 is a side cut-away view of an embodiment of the disclosure.

FIG. 5 is a bottom view of an embodiment of the disclosure.

### DESCRIPTION OF THE PREFERRED EMBODIMENT

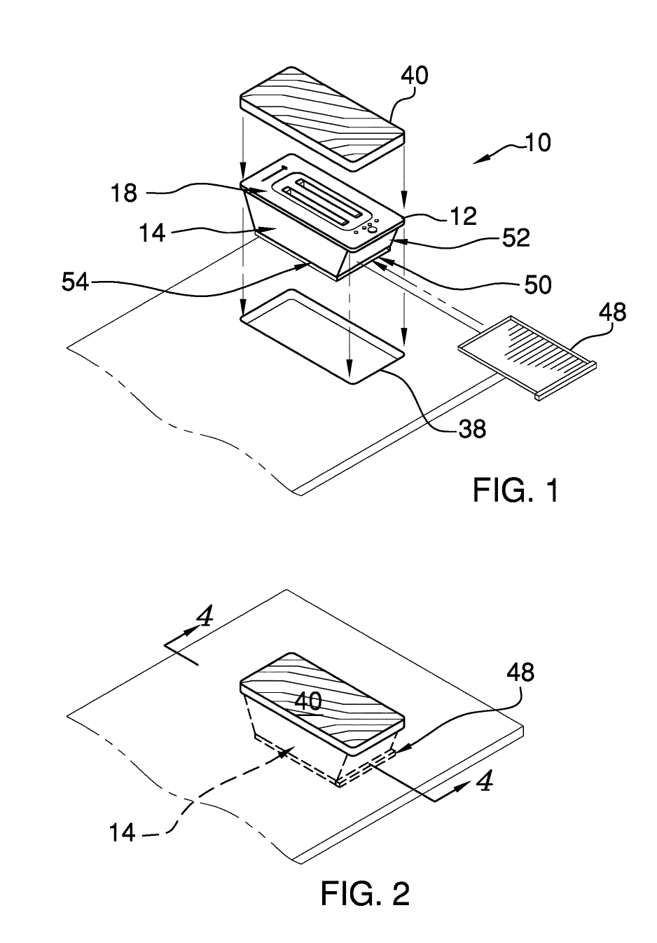

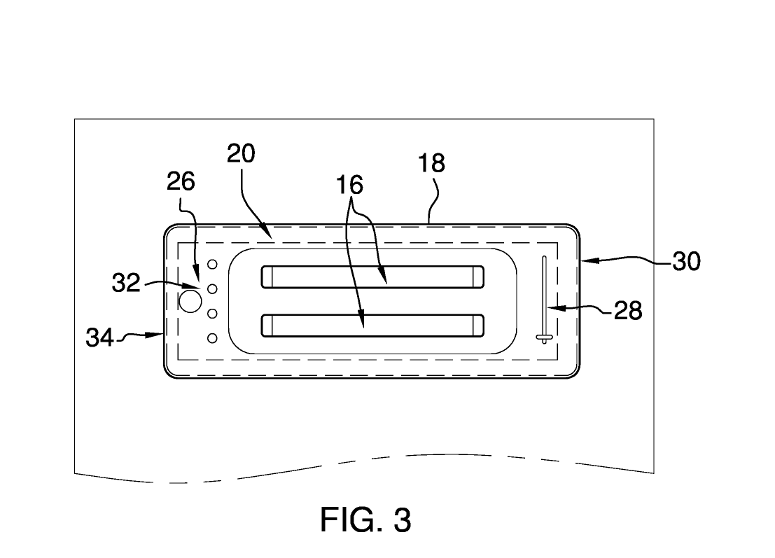

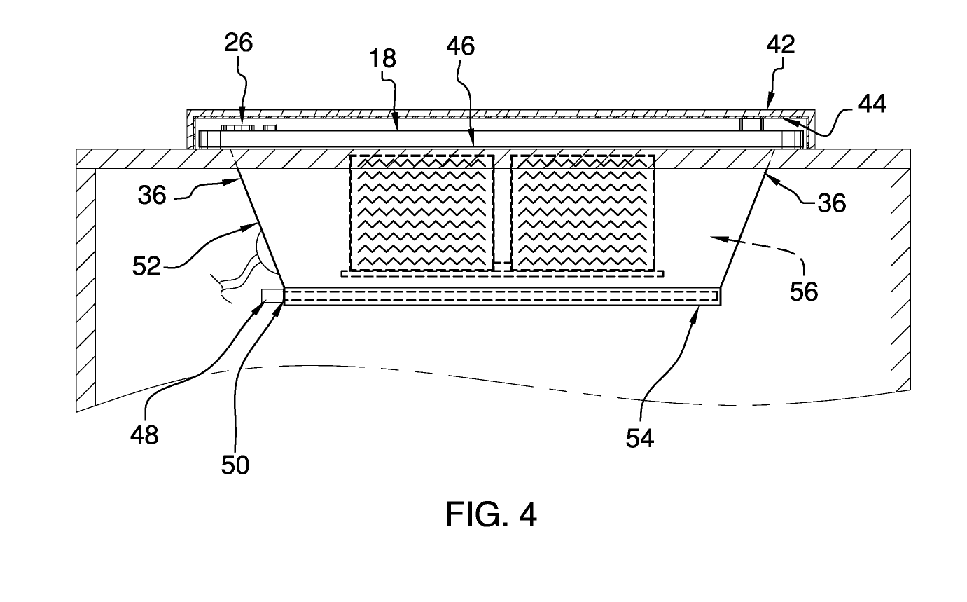

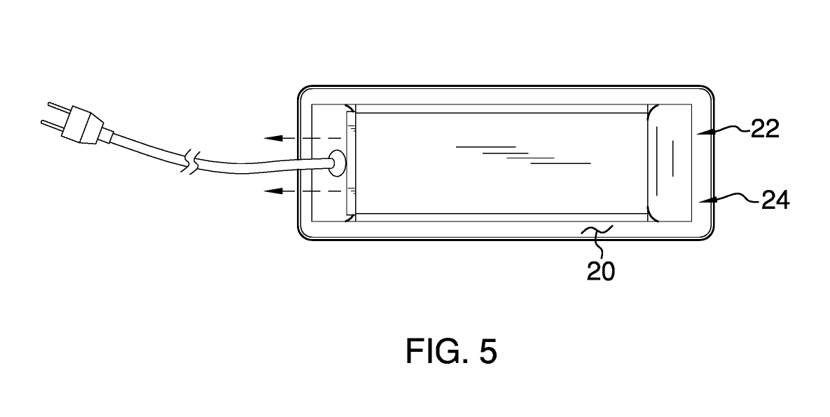

With reference now to the drawings, and in particular to FIGS. 1 through 5 thereof, a new toasting device embodying the principles and concepts of an embodiment of the disclosure and generally designated by the reference numeral 10 will be described.

As best illustrated in FIGS. 1 through 5, the surface-mounted toasting device 10 generally comprises a toaster 12. The toaster 12 has a housing 14 comprised of heat resistant plastic. The toaster 12 has a plurality of slots 16. The plurality of slots 16 may comprise two slots. A top 18 is coupled to the housing 14. The top 18 extends outwardly past the housing 14 to form a rim 20. The top 18 is comprised of stainless steel. A seal 22, complimentary to the rim 20, is coupled to an underside 24 of the rim 20. The seal 22 is comprised of rubber and is heat resistant.

A control panel 26 is coupled to and positioned in the top 18 of the toaster 12. The control panel 26 comprises a light/dark selector 28 positioned at a first end 30 of the top 18, and on/off, up/down, cancel and timer selectors 32 positioned at a second end 34 of the top 18. A plurality of retainers 36 is coupled to the housing 14 proximate to the top 18.

The device 10 also includes a template 38 that is complimentary to the housing 14 and a cover 40 that is complimentary to the top 18. The cover 40 has an exterior surface 42 bonded to an interior surface 44. The exterior surface 42 comprises wood and the interior surface 44 is heat resistant. The cover 40 is box-shaped with an open face 46 that is complimentary to the top 18.

In use, the template 38 can be positioned on the mounting surface to facilitate creation of the complimentary opening required to position the housing 14 in the opening with the top 18 retained by the rim 20 at the surface level, such that the retainers 36 are positioned on the housing 14 so as to be engagable to the underside of the mounting surface to secure the toaster 12 in the complimentary opening, such that the cover 40 is positionable over the top 18 when the toaster 12 is not in use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A surface-mounted toasting device comprising:
a toaster, said toaster having a housing;
a top, said top being coupled to said housing, said top extending outwardly past said housing forming a rim;
a seal, said seal being complimentary to said rim, said seal being coupled to an underside of said rim;
a control panel, said control panel being coupled to and positioned in said top of said toaster; and
a cover, said cover being complimentary to said top.

2. The device of claim 1, further including said housing being comprised of heat resistant plastic.

3. The device of claim 1, further including said toaster having a plurality of slots.

4. The device of claim 3, further including said plurality of slots comprising two slots.

5. The device of claim 1, further including said top being comprised of stainless steel.

6. The device of claim 1, further including said seal being comprised of rubber.

7. The device of claim 6, further including said seal being heat resistant.

8. The device of claim 1, further comprising:
said control panel comprising a light/dark selector positioned at a first end of said top; and
said control panel comprising on/off, up/down, cancel and timer selectors being positioned at a second end of said top.

9. The device of claim 1, further including a plurality of retainers, said retainers being coupled to said housing proximate to said top, wherein said retainers are positioned on said housing so as to be engagable to the underside of the mounting surface to secure said device in the complimentary opening.

10. The device of claim 1, further including a template, said template being complimentary to said housing, wherein said template can be positioned on the mounting surface to facilitate creation of the complimentary opening required to position said housing in the opening with said top being retained by said rim at the surface level.

11. The device of claim 1, further comprising:
said cover having an exterior surface bonded to an interior surface;
said exterior surface comprising wood; and
said interior surface being heat resistant.

12. The device of claim 11, further including said cover being box-shaped with an open face, said open face being complimentary to said top, wherein said cover is positionable over said top when said toaster is not in use.

13. A surface-mounted toasting device comprising:
a toaster, said toaster having a housing, said housing being comprised of heat resistant plastic, said toaster having a plurality of slots, said plurality of slots comprising two slots;
a top, said top being coupled to said housing, said top extending outwardly past said housing forming a rim, said top being comprised of stainless steel, wherein said rim is positioned to retain said top of said toaster at a surface level when said housing is positioned in a complimentary opening in the surface;
a seal, said seal being complimentary to said rim, said seal being coupled to an underside of said rim, said seal being comprised of rubber, said seal being heat resistant;
a control panel, said control panel being coupled to and positioned in said top of said toaster, said control panel comprising a light/dark selector positioned at a first end of said top and on/off, up/down, cancel and timer selectors being positioned at a second end of said top;
a plurality of retainers, said retainers being coupled to said housing proximate to said top, wherein said retainers are positioned on said housing so as to be engagable to the underside of the mounting surface to secure said device in the complimentary opening;
a template, said template being complimentary to said housing, wherein said template can be positioned on the mounting surface to facilitate creation of the complimentary opening required to position said housing in the opening with said top being retained by said rim at the surface level; and
a cover, said cover being complimentary to said top, said cover having an exterior surface bonded to an interior surface, said exterior surface comprising wood, said interior surface being heat resistant, said cover being box-shaped with an open face, said open face being complimentary to said top, wherein said cover is positionable over said top when said toaster is not in use.
